(19) United States
(12) Patent Application Publication
(10) Pub. No.: US 2011/0063175 A1
(43) Pub. Date: Mar. 17, 2011

(54) PORTABLE WIRELESS DEVICE

(75) Inventors: Hiroyuki Uno, Miyagi (JP); Masashi Koshi, Miyagi (JP); Tomoaki Nishikido, Miyagi (JP); Yoshio Koyanagi, Kanagawa (JP); Kenya Nagano, Miyagi (JP)

(73) Assignee: PANASONIC CORPORATION, Osaka (JP)

(21) Appl. No.: 12/992,406

(22) PCT Filed: Feb. 23, 2009
(86) PCT No.: PCT/JP2009/000768

§ 371 Date: Nov. 12, 2010

(30) Foreign Application Priority Data
May 14, 2008 (JP) 2008-127113

(51) Int. Cl. H01Q 1/24

(52) U.S. Cl. 343/702

(57) ABSTRACT

There is provided a foldable portable radio capable of exhibiting high communication performance despite its slimness and compact housings.

The portable radio has an upper housing 11 in which an upper circuit board 11A is placed; a lower housing 12A in which a lower circuit board 12 is placed; a conductive hinge 13A that joins the upper housing 11 to the lower housing 12 so as to be rotatable around one axis; an antenna element 14 placed in vicinity of the hinge 13A parallel to an axial direction of the hinge 13A; and a feed section 15 connected to a radio circuit 17 on the lower circuit board 12A. The antenna element 14 is electrically connected to the feed section 15, and the hinge 13A is connected as a ground, whereby the hinge 13A and the antenna element 14 operate as a dipole antenna.

### TECHNICAL FIELD

The present invention relates to a slim foldable portable radio exhibiting high communication performance.

### BACKGROUND ART

Various portable radios such as for instance portable phones, have hitherto been developed. Further, in relation to the portable phones, various foldable portable phones that are open-able and closable around a hinge section have already been developed. In such a foldable portable phone, since a display section is provided in an upper housing, a radio circuit is set in a lower housing because of a limited space in many times. Further, in order to minimize a transmission loss occurring between the radio circuit and an antenna, it is preferable to place the antenna in close proximity to the radio circuit. With this being the case, in order to reduce the transmission loss occurring between the radio circuit and the antenna and minimize influence of a hand on a communication state, the antenna is placed in close proximity to the hinge section of the lower housing in many cases. For instance, a collapsible foldable phone, such as that shown in FIG. 9, has hitherto been known as a specific example of such a foldable portable phone (see; for instance, Patent Document 1).

As shown in FIG. 9, a foldable portable phone 100 has a first antenna element 104 placed in an upper housing 101; a conductor element 105 that is placed in a lower housing 102 and that makes up a dipole antenna in conjunction with the first antenna element 104; a second antenna element 106 making up a monopole antenna placed in the lower housing 102 close to a hinge section 103; a first feed section 107 placed at one side end of the first antenna element 104; a second feed section 108 that is placed on one side end of the second antenna element 106 facing the first feed section 107 and that feeds electric power to the second antenna element 106 through unbalanced feeding; and a high frequency switch 109 that selects between the first antenna element 104 and the second antenna element 106, as required, and makes a switch to the selected antenna element. In the drawing, the reference numeral 110 designates a matching circuit; the reference numeral 111 designates a radio circuit; the reference numeral 112 designates a switch control section; and 113 designates an open-close sensor.

By the way, the foldable portable phone requires setting of a high frequency switch, or the like; hence, a configuration of the phone becomes complicate correspondingly. In such a foldable portable phone, it is common to use the housing of the portable phone by hand. Therefore, it is desirable to place the antenna at a location where the antenna undergoes as little influence of hand as possible. Incidentally, in the foldable portable phone shown in FIG. 9, an electric current flowing through the lower housing is large; therefore, gain deterioration which will arise when the phone is used while gripped is great.

For this reason, a portable phone 200, such as that shown in FIG. 10, has also been developed (see; for instance, Patent Document 2). Specifically, the portable phone 200 has an upper housing 201 accommodating a first circuit board 204; a second circuit board 205 to be electrically connected to the first circuit board 204 and that is joined to the upper housing 201 by way of a hinge section 203; an antenna element 206 incorporated in the upper housing 201; a feed section 207 that is placed on the first circuit board 204 and that is electrically connected to the antenna element 206; and a coaxial line path 208 that electrically connects the first circuit board 204 to the second circuit board 205. In the drawing, the reference numeral 209 designates a radio circuit, and the reference numeral 210 designates an FPC (flexible cable).

Patent Document 1: JP-A-2004-229048

Patent Document 2: JP-A-2007-158915

### DISCLOSURE OF THE INVENTION

### Problem that the Invention is to Solve

However, a tendency, for placing an emphasis on a design at the time of purchase of a portable radio, such as a portable phone, has recently become stronger. In order to prevent impairment of the design of the portable phone, a desire for minimizing projection of an antenna out of housings has become stronger. Moreover, when an attempt is made to reduce; for instance, the thickness of a housing of a portable phone shown in FIG. 10, the antenna element 206 and the hinge section 203 get closer to each other, with the result that an antenna characteristic is degraded by coupling between the antenna element and the hinge section. Further, since a feed section is provided in an upper housing equipped with a display section that accounts for a large area of the housing, a footprint eventually increases.

In the portable phone shown in FIG. 10, the antenna element 206 is incorporated in the upper housing 201 that is little affected by hand; hence, occurrence of gain deterioration, which would otherwise arise when the portable phone is used by hand, can be avoided. Accordingly, the antenna element works in this respect. However, the antenna element operates as a monopole antenna while the upper housing 201 is taken as a ground. Hence, an electric current flowing through the upper housing 201 is large, and a vertical polarization component is greater than a horizontal polarization component. As a consequence, the horizontal polarization component accounts for the most part during communication, which can sometimes induce a drop in communication gain.

The present invention has been conceived in light of the circumstance and aims at providing a foldable portable radio that can exhibit high communication performance despite its slimness and compact housings.

### Means for Solving the Problem

A portable radio of the present invention has a first housing in which a first circuit board is placed; a second housing in which a second circuit board is placed; a first hinge joining the first housing and the second housing to each other so as to be rotatable around one axis and having a conductivity; an antenna element that is placed in a vicinity of the first hinge and that is placed substantially parallel to an axial direction of the first hinge; and a feed section connected to a radio circuit on the first or second circuit board, wherein the first hinge and the antenna element operate as a dipole antenna as a result of the antenna element being electrically connected to the feed section and also the first hinge being connected as a ground. By means of the configuration, the first hinge is used as a ground. Hence, deterioration of an antenna characteristic attributable to a coupling between an antenna and a hinge can be ignored. An attempt can be made to correspondingly reduce the thickness of the housings. Since an electric current concentrates on the first hinge and the antenna element, gain deterioration can be diminished even when the portable radio is gripped by hand. Moreover, since the first hinge and the antenna element operate as a dipole, vertical polarization components become dominant during communication, and a high communication characteristic can be exhibited.

An overlap between the antenna element and the first hinge achieved in their longitudinal directions can also be set to about one-half or less of the length of the antenna element. By means of the configuration, electromagnetic coupling between the antenna element and the first hinge becomes small, and deterioration of a communication characteristic can be prevented.

The feed section may also be electrically connected to a radio circuit placed on the first or second circuit board by way of a coaxial line path, and an exterior conductor of the coaxial line path may electrically connect the first hinge to a ground of the first or second circuit board. Since the hinge can excite the antenna element by serving as a ground regardless of a location in which the radio circuit is placed, an attempt can be made to reduce the size and thickness of the portable radio while high communication performance is maintained.

A length of the coaxial line path is preferably about quarter of a wavelength corresponding to an operating frequency of the dipole antenna made up of the antenna element and the first hinge. It is thereby possible to prevent leakage of a signal from the coaxial line path to the first or second circuit board, and influence of the hand on communication can be diminished.

The portable radio can also be configured so as to further include an impedance matching circuit between the antenna element and the feed section, and a ground of the impedance matching circuit and the first hinge may also be electrically connected together. Since there is no necessity for providing an additional ground, an attempt can be made to decrease the size and thickness of the portable radio.

The portable radio of the present invention further includes at least one of a first filter and a second filter that sections a resonance frequency of the dipole antenna made up of the antenna element and the first hinge, and the first filter may be placed on the first circuit board and has one end electrically connected to the antenna element and a remaining end electrically connected to a ground of the first circuit board; and the second filter may be placed on the second circuit board and has one end electrically connected to the first hinge and a remaining end electrically connected to a ground of the second circuit board. As a result, it becomes possible to build a dipole antenna having two different operating frequencies of the first dipole antenna made up of the antenna element and the hinge and the second dipole antenna made up of the first and second circuit boards. A multi-band antenna having two frequencies can be accomplished without addition of antenna components.

The portable radio can also be configured so as to further include a second conductive hinge that joins the first housing to the second housing so as to be rotatable around a remaining axis orthogonal to the one axis. As a result, an attempt can be made to reduce the size and thickness of a portable radio that is open-able and closable in both the longitudinal and lateral directions.

The portable radio can also be configured so as to further include at least one of a first reactance element having one end electrically connected to the first hinge and a remaining end electrically connected to the second hinge; a second reactance element having one end electrically connected to the first hinge and a remaining end electrically connected to the ground of the first circuit board or the second circuit board; and a third reactance element having one end electrically connected to the second hinge and a remaining end electrically connected to the ground of the first or second circuit board. As a result, it becomes possible to prevent deterioration of an antenna characteristic, which would otherwise be caused by coupling between the hinge and the antenna element.

### ADVANTAGE OF THE INVENTION

A portable radio of the present invention includes a first housing in which a first circuit board is placed; a second housing in which a second circuit board is placed; a first conductive hinge that joins the first housing and the second housing to each other so as to be rotatable around one axis; an antenna element that is placed in a vicinity of the first hinge and that is placed substantially parallel to an axial direction of the first hinge; and a feed section connected to a radio circuit on the first or second circuit board, wherein the first hinge and the antenna element operate as a dipole antenna as a result of the antenna element being electrically connected to the feed section and also the first hinge being connected as a ground. The portable radio can exhibit high communication performance despite its slimness and compact housings.

### BRIEF DESCRIPTION OF THE DRAWINGS

FIG. 1 is a front view showing a foldable portable phone of a first embodiment of the present invention.

FIG. 2 is an oblique perspective view showing a configuration of a first hinge of the present invention.

FIG. 3 is a general oblique perspective view showing the configuration of the hinge of the first embodiment of the present invention.

FIG. 4 is a front view showing a foldable portable phone of a second embodiment of the present invention.

FIGS. 5 (A) and (B) are a front view and a side view showing a state of a biaxial foldable portable phone of a third embodiment of the present invention when the phone is opened in its longitudinal direction.

FIGS. 6 (A) and (B) are a front view and a side view showing a state of the biaxial foldable portable phone of the third embodiment of the present invention when the phone is opened in its lateral direction.

FIGS. 7 (A) is an oblique perspective view showing a configuration of a second hinge of the third embodiment of the present invention, and (B) is an oblique perspective view showing a turning state of the hinge.

FIG. 8 is a front view showing a foldable portable phone of a fourth embodiment of the present invention.

FIGS. 9 (A) and (B) are a plan view and a side view showing a configuration of a related art foldable portable phone.

FIG. 10 is a plan view showing a configuration of another related art foldable portable phone.

### DESCRIPTIONS OF THE REFERENCE NUMERALS AND SYMBOLS

10, 20, 30, 40 FOLDABLE PORTABLE PHONE
11 UPPER HOUSING (FIRST HOUSING)
11A FIRST CIRCUIT BOARD (UPPER CIRCUIT BOARD)
12 LOWER HOUSING (SECOND HOUSING)
12A SECOND CIRCUIT BOARD (LOWER CIRCUIT BOARD)
13 HINGE
13A HINGE ELEMENT (FIRST HINGE: FIRST HINGE ELEMENT)
13B HINGE ELEMENT (SECOND HINGE: SECOND HINGE ELEMENT)
133A GROUND
14 ANTENNA ELEMENT
15 FEED SECTION
16 IMPEDANCE MATCHING SECTION
17 RADIO CIRCUIT
21 UPPER FILTER
22 LOWER FILTER
41 FIRST REACTANCE ELEMENT
42 SECOND REACTANCE ELEMENT
43 THIRD REACTANCE ELEMENT

### BEST MODES FOR IMPLEMENTING THE INVENTION

Preferred embodiments of the present invention are hereunder described in detail by reference to the drawings.

### First Embodiment

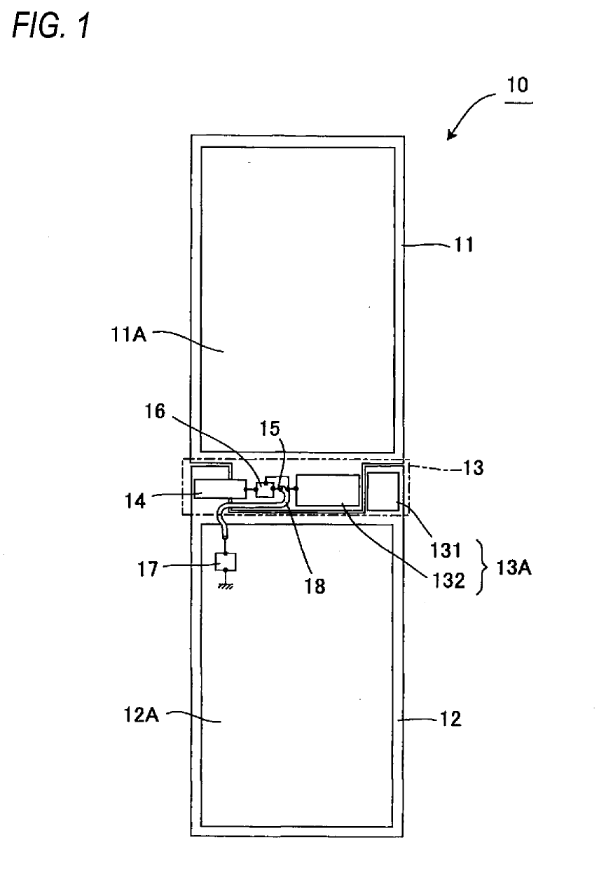

FIG. 1 shows a foldable portable phone 10 of a first embodiment of a portable radio of the present invention. The foldable radio 10 has an upper housing 11 making up a first housing; a lower housing 12 making up a second housing; a hinge 13 that joints the upper housing 11 to the lower housing 12 in a rotatable manner; an antenna element 14; a feed section 15; an impedance matching circuit 16; a radio circuit 17; and a coaxial line path 18.

The upper housing 11 has an un-illustrated display section and a first circuit board (an upper circuit board) 11A. The lower housing 12 has an un-illustrated operation section, a second circuit board (a lower circuit board) 12A, and the foregoing radio circuit 17.

The hinge 13 has a hinge element 13A making up the first hinge, the foregoing antenna element (a first antenna element) 14, the feed section 15, and the impedance matching circuit 16. In particular, details of the hinge 13 of the present embodiment are described later. The antenna element 14, the feed section 15, the impedance matching section 16, a ground 134, a spring connector 134C, and the like, are placed on a substrate (a flexible printed board) 133 that is positioned along a direction of a rotary shaft of the hinge 13 and that assumes a substantially rectangular shape.

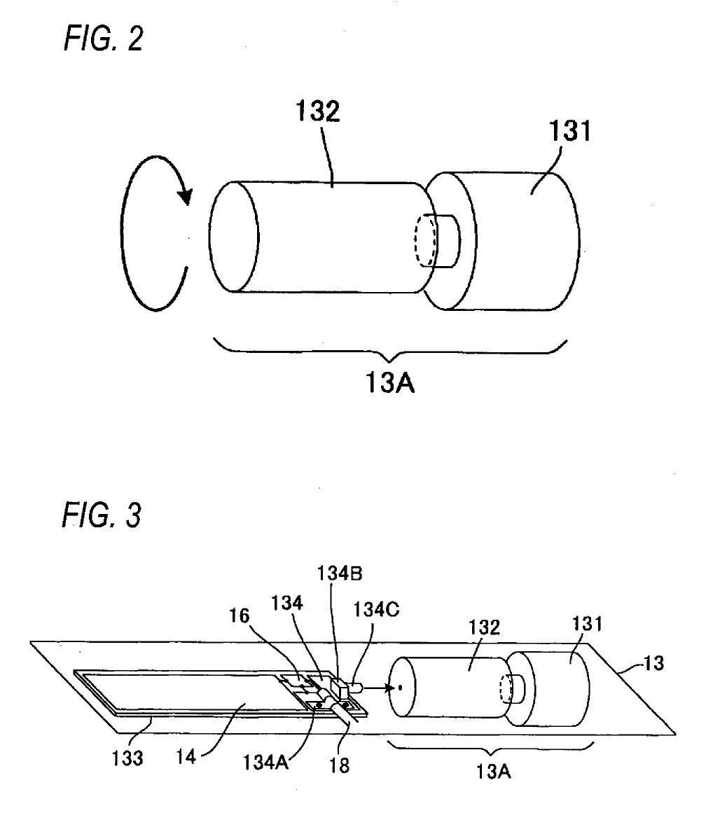

As shown in FIG. 2, the hinge element 13A includes a hinge fixing section 131 and a hinge turning section 132 that is attached to the hinge fixing section 131 in a rotatable manner. Both the hinge fixing section and the hinge turning section are made of a conductive material. The hinge fixing section 131 is fixed to the lower housing 12, and the hinge turning section 132 is fixed to the upper housing.

As shown in FIG. 3, the ground 134 is made of a conductor (e.g. copper foil) placed on the substrate 133. A coaxial line path fixing section 134A and a spring connector fixing section 134B that each are formed from a conductive material are fixed to the ground 134. The coaxial line path fixing section 134A and the spring connector fixing section 134B are electrically connected to each other by way of the ground 134.

One end of the coaxial line path 18 is fixed to the coaxial line path fixing section 134A, whereby a desired degree of strength is assured. A base end of the spring connector 134C is fixed to the spring connector fixing section 134B. The spring connector 134C makes an electrical connection with the hinge element 13A while maintaining a state of being rotatable with respect to the hinge turning section 132. Therefore, a ground of the lower circuit board 12A is electrically connected to the hinge element 13A. The antenna element 14 is electrically connected to the radio circuit 17 by way of the impedance matching circuit 16 on the substrate 133, the feed section 15, and an interior conductor in the coaxial line path 18.

The feed section 15 is in the hinge 13 and electrically connected to the radio circuit 17 placed on the second circuit board by way of the interior conductor in the coaxial line path.

The impedance matching circuit 16 attempts to achieve impedance matching between the antenna element 14 and the interior conductor in the coaxial line path.

As mentioned previously, the antenna element 14 and the hinge element 13A are electrically connected together by way of the impedance matching circuit 16. Specifically, the antenna element 14 and the hinge element 13A make up a dipole antenna. A desirable length of the coaxial line path 18 is made, in consideration of prevention of leakage of a radio wave into the second circuit board, so as to come to about a quarter of a wavelength λ1 corresponding to an operating frequency (f1) of the dipole antenna (a first dipole antenna) made up of the antenna element 14 and the hinge element 13A.

Although un-illustrated, a mesh-shaped exterior conductor and an interior conductor made of a wire; for instance, are provided in the coaxial line path 18. One end of the exterior conductor of the coaxial line path 18 is secured to a conductive coaxial line path fixing section 134A, and the other end of the exterior conductor is connected to the ground of the lower circuit board 12A. Specifically, the ground 134 is connected to the ground of the lower circuit board 12A by way of the exterior conductor.

One end of the interior conductor of the coaxial line path 18 is connected to the antenna element 14 by way of the impedance matching circuit 16 and the other end of the interior conductor of the coaxial line path 18 is connected to the radio circuit 17. As a consequence, the antenna element 14 and the hinge element 13A are electrically connected to the wireless circuit 17 by way of the impedance matching circuit 16.

Accordingly, the antenna element 14 and the hinge element 13A that make up the antenna are placed on the hinge 13. Antenna space does not need to be provided in the upper housing 11 and the lower housing 12. Therefore, it is possible to realize compact housings, and the antenna portion does not need to project out of the housings. Hence, it is possible to prevent impairment of appearance of the portable radio.

According to the present embodiment, the hinge is used as a ground of the antenna element. Therefore, deterioration of a characteristic attributable to coupling between the hinge and the antenna element can be ignored. A configuration for assuring a minimum distance between the upper housing 11, the lower housing 12 and the hinge 13, such as that hitherto been required, becomes obviated; hence, the thickness of the housings can be reduced.

Further, according to the present embodiment, an electric current concentrates on the antenna element and the hinge. Accordingly, gain deterioration, which would otherwise be caused when the lower housing is gripped by hand, can be avoided. Because of operation of the dipole antenna made up of the antenna element and the hinge element 13A, the vertical polarization component can be increased during communication, and a communication characteristic becomes better.

In the present embodiment, the hinge is placed so as to turn in the longitudinal direction of the housings. However, even when the hinge is arranged so as to turn in a widthwise direction of the housings, a similar advantage can be yielded.

An overlap between the antenna element 14 and the first hinge element 13A in their longitudinal directions may be set to about one-half or less of the length of the antenna element 14. By means of the configuration, electromagnetic coupling between the antenna element and the first hinge becomes smaller, and deterioration of the communication characteristic can be prevented.

### Second Embodiment

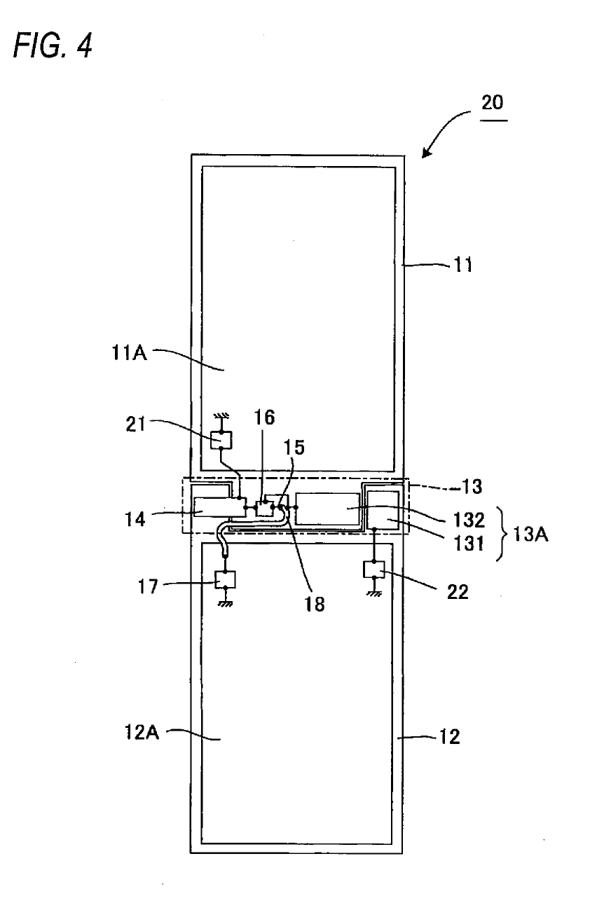

A second embodiment of the present invention is now described in detail by reference to FIG. 4. In the present embodiment, the elements that are identical with those of the portable phone described in connection with the first embodiment are assigned the same reference numerals, and their repeated explanations are omitted.

A foldable portable phone 20 of the present embodiment differs from the foldable portable phone of the first embodiment in that the phone has an upper filter 21 and a lower filter 22.

The antenna element 14 and the upper circuit board 11A are electrically connected to each other by way of the upper filter 21. The upper filter 21 hinders flow of, to the upper circuit board 11A, a high frequency current having an operating frequency f1 (a first frequency) of the first dipole antenna made up of the antenna element 14 and the hinge element 13A of the first embodiment.

The hinge element 13A and the lower circuit board 12A are electrically connected to each other by way of the lower filter 22. As does the upper filter 21, the lower filter 22 hinders flow of the high frequency current having the operating frequency f1 from the hinge element 13 to the lower circuit board 12A.

In the present embodiment, two filters having an identical configuration; namely, the upper filter 21 and the lower filter 22, are placed. However, there may also be adopted a configuration in which only one of the filters is placed. The configuration of the filters is assumed to encompass an LC parallel resonance circuit, an LC serial resonance circuit, and the like.

In the embodiment, the antenna element 14, the upper circuit board 11A and the hinge element 13A, the lower circuit board 12A act as a second dipole antenna. An electrical length of the second dipole antenna (made up of the antenna element 15 and the hinge element 13A of the first embodiment) is longer than an electrical length of the first dipole antenna, and an operating frequency f2 of the second dipole antenna is lower than the operating frequency f1 of the first dipole antenna (f2<f1).

Therefore, according to the present embodiment, there can be configured multi-band slim housings that cover two frequency bands. Further, a multi-band configuration can be realized by merely setting one antenna element. Therefore, cost reduction can also be accomplished.

### Third Embodiment

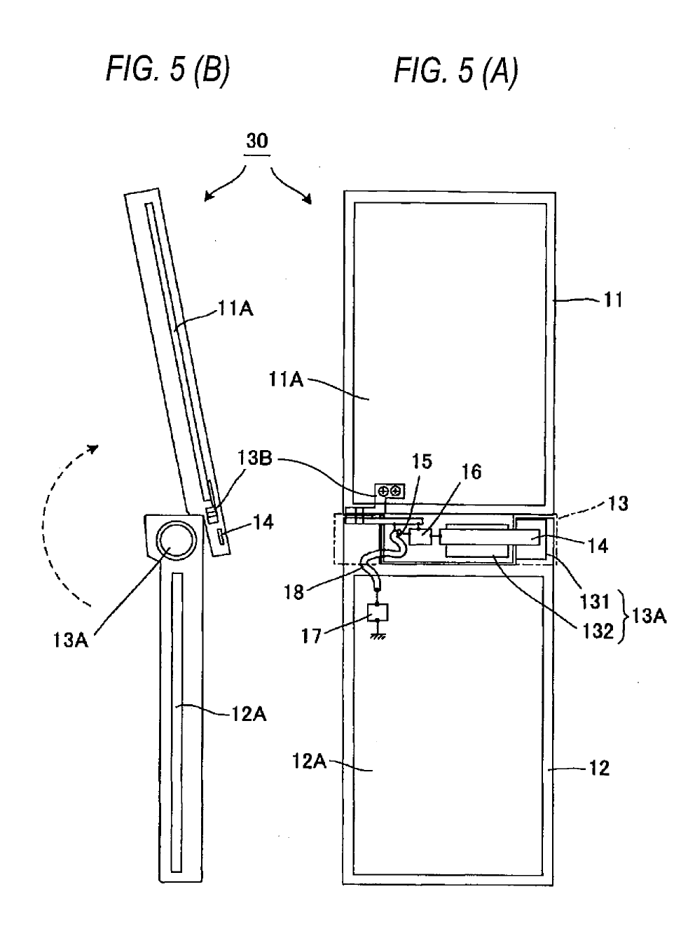

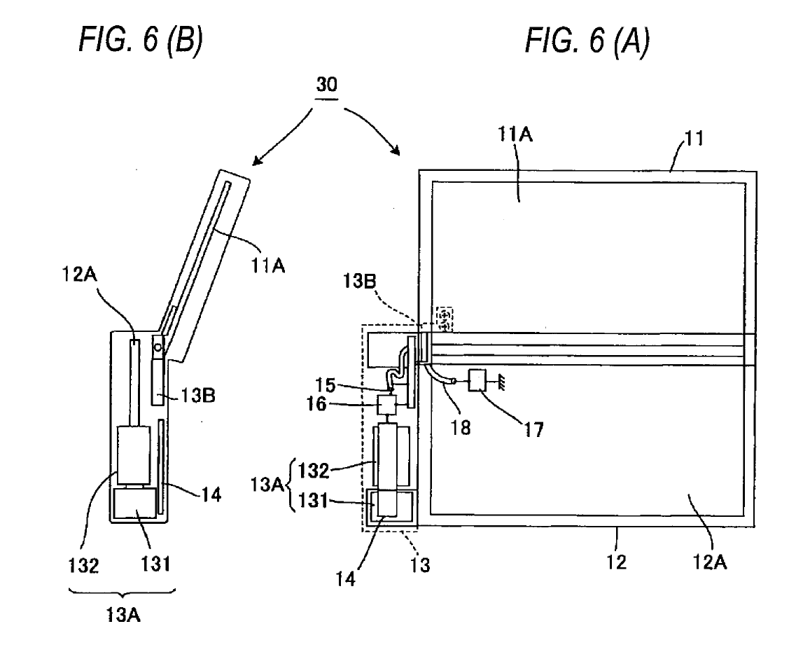

A third embodiment of the present invention is now described in detail by reference to FIGS. 5 and 6. In the embodiment, the elements that are identical with those of the portable phone described in connection with the first embodiment are assigned the same reference numerals, and their repeated explanations are omitted.

Unlike the foldable portable phones described in connection with the first and second embodiments, a foldable portable phone 30 of the present embodiment works as a biaxial foldable portable phone in which the upper housing 11 and the lower housing 12 are open-able and closable in the horizontal direction (a lateral direction) shown in FIG. 6 as well as in the vertical direction (a longitudinal direction) shown in FIG. 5.

Accordingly, the foldable portable phone 30 of the present embodiment has the upper housing 11, the lower housing 12, the hinge 13, the feed section 15, the impedance matching circuit 16, the radio circuit 17, the antenna element 14, a longitudinal opening hinge element (hereinafter called a “first hinge element”) 13A, and also a hinge element (hereinafter called a “second hinge element”) 13B making up a lateral opening second hinge.

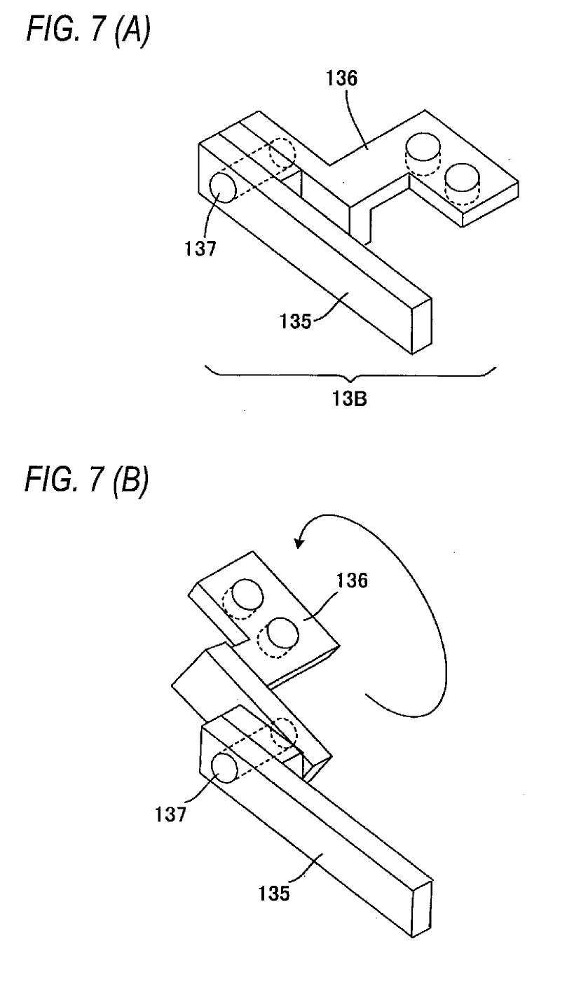

As shown in FIG. 7, the second hinge element 13B has a hinge fixing section 135 and a hinge turning section 136 that can laterally turn around a rotary shaft 137 with respect to the hinge fixing section 135. The hinge fixing section 135 is fixed to the hinge 13, and the hinge turning section 136 is fixed to the upper housing 11. At this time, the hinge 13B and the upper housing 11 may be electrically connected or unconnected. The rotary shaft 137 makes up a shaft that lets the upper housing and the lower housing turn in a direction orthogonal to the rotary shaft of the hinge element 13A, and joins the hinge fixing section 135 to the hinge turning section 136 in a rotatable manner. All of the hinge fixing section 135, the rotary shaft 137, and the hinge turning section 136 are formed from a conductive material.

The present embodiment differs from the first and second embodiments in that the second hinge element 13B is used as an antenna ground and that the second hinge element 13B and the lower circuit board 12A are electrically connected to each other by way of the exterior conductor of the coaxial line path 18. The antenna element 14 is electrically connected to the radio circuit 17 by way of the impedance matching circuit 16, the feed section 15, and the interior conductor of the coaxial line path 18.

The antenna element 14 and the second hinge element 13B thereby make up a dipole antenna. Like the first embodiment, the coaxial line path 18 is formed so as to have a length of about a quarter of a wavelength corresponding to the operating frequency of the dipole antenna made up of the antenna element 14 and the second hinge element 13B.

By adoption of the configuration, the antenna element 14 and the matching circuit 16, which make up the antenna, can be placed in the hinge 13 in the third embodiment having a biaxial hinge configuration. A necessity for placing an antenna in the upper and lower housings becomes obviated, and hence miniaturization of the portable phone becomes possible.

In any of states of the housings shown in FIGS. 5 and 6, the dipole antenna can be configured in the hinge 13, and superior antenna performance can be accomplished.

### Fourth Embodiment

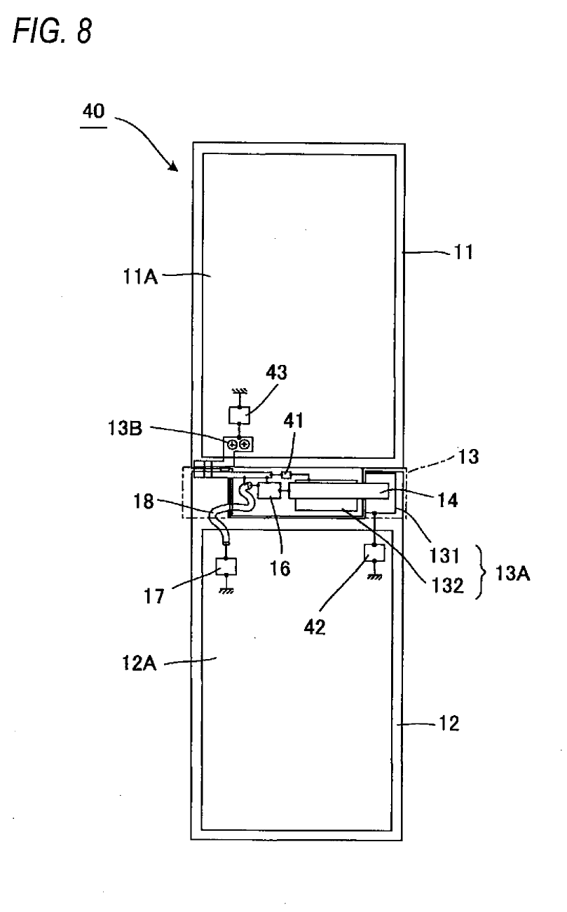

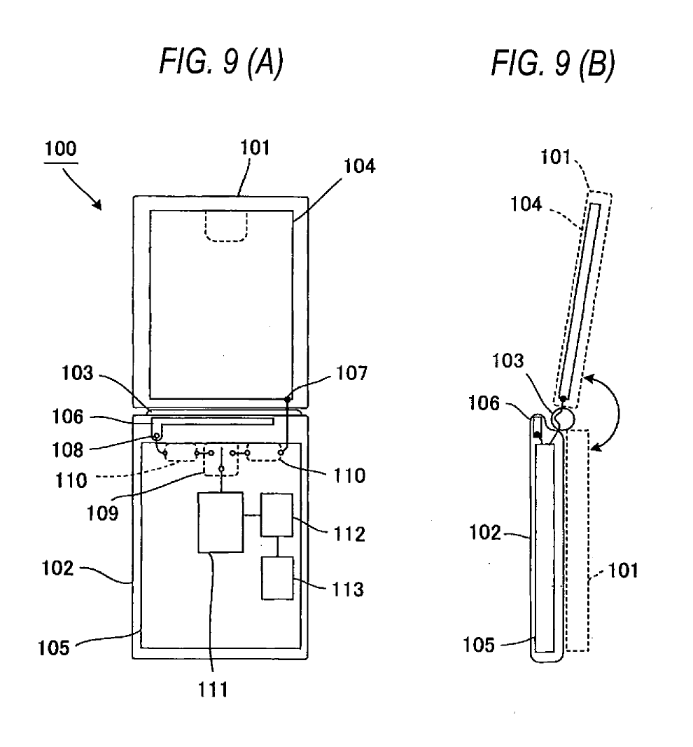

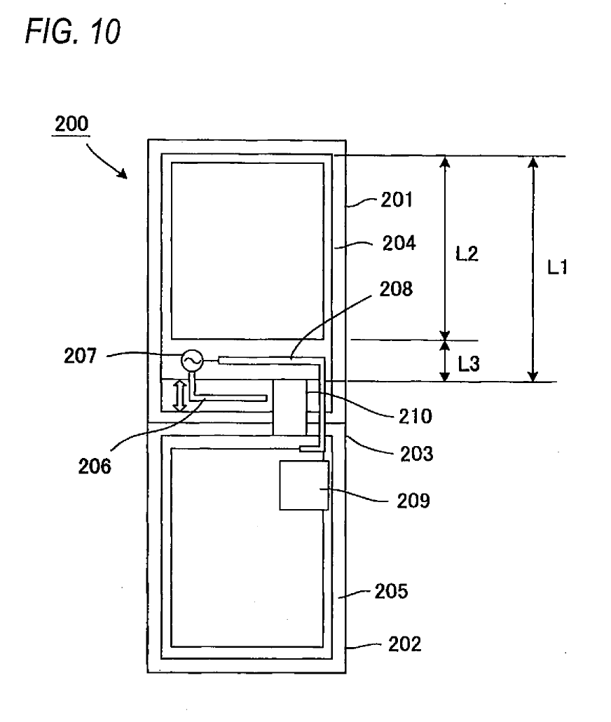

A fourth embodiment of the present invention is now described in detail by reference to FIG. 8. Even in the present embodiment, the elements that are identical with the elements of the portable phones described in connection with the first and third embodiments are assigned the same reference numerals, and their repeated explanations are omitted.

Unlike the foldable portable phone 30 described in connection with the third embodiment, a foldable portable phone 40 of the present embodiment has a first reactance element 41, a second reactance element 42, and a third reactance element 43. In the embodiment, not all of the reactance elements are always required, any one or two of them may also be employed.

The first reactance element 41 is inserted between the hinge element 13A and the second hinge element 13B, and the second reactance element 42 is inserted between the hinge element 13A and the lower circuit board 12A. As a result of insertion of the reactance elements, it is possible to prevent performance deterioration, which would otherwise be caused by electromagnetic field coupling between the hinge element 13A and the dipole antenna made up of the antenna element 14 and the second hinge element 13B.

The third reactance element 43 is inserted between the second hinge element 13B and the upper circuit board 11A. It thereby becomes possible to prevent performance deterioration, which would otherwise be caused by electromagnetic field coupling between the hinge and a signal cable (not shown) that connects the upper circuit board 11A to the lower circuit board 12A.

Therefore, in the present embodiment, the biaxial foldable portable phone can prevent deterioration of an antenna characteristic, which would otherwise be caused by electromagnetic field coupling between the hinge and the signal cable connecting the upper and lower circuit boards together. Further, an attempt can also be made to reduce the thickness of the housings.

The present invention is not particularly limited to the embodiments and can be implemented in various forms to such an extent that it does not depart the gist of the invention.

Although the present invention has been described in detail by reference to the specific embodiments, it is manifest to the persons who are skilled in the art that the present invention be susceptible to various alterations or modifications without departing the spirit and scope of the present invention.

The present patent application is based on Japanese Patent Application No. 2008-127113 filed on May 14, 2008, the entire subject matter of which is incorporated herein by reference.

### INDUSTRIAL APPLICABILITY

The portable phone of the present invention yields an advantage of the ability to exhibit high communication performance despite its slimness and compact housings and is useful for; for instance, a foldable portable phone.

1. A portable radio comprising:
a first housing in which a first circuit board is placed;
a second housing in which a second circuit board is placed;
a first hinge joining the first housing and the second housing so as to be rotatable around one axis and having a conductivity;
an antenna element that is placed in a vicinity of the first hinge and that is placed substantially parallel to an axial direction of the first hinge; and
a feed section connected to a radio circuit on the first circuit board or the second circuit board, wherein the first hinge and the antenna element operate as a dipole antenna as a result of the antenna element being electrically connected to the feed section and the first hinge being connected as a ground.

2. The portable radio according to claim 1, wherein an overlap between the antenna element and the first hinge in a longitudinal direction is about one-half of a length of the antenna element or less.

3. The portable radio according to claim 1, wherein the feed section is electrically connected to a radio circuit placed on the first or second circuit board by a coaxial line path, and an exterior conductor of the coaxial line path electrically connects the first hinge to a ground of the first circuit board or the second circuit board.

4. The portable radio according to claim 3, wherein a length of the coaxial line path is about quarter of a wavelength corresponding to an operating frequency of the dipole antenna made up of the antenna element and the first hinge.

5. The portable radio according to claim 1, further comprising an impedance matching circuit between the antenna element and the feed section, wherein a ground of the impedance matching circuit and the first hinge are electrically connected together.

6. The portable radio according to claim 1, further comprising at least one of a first filter and a second filter that sections a resonance frequency of the dipole antenna made up of the antenna element and the first hinge, wherein the first filter is placed on the first circuit board and has one end electrically connected to the antenna element and a remaining end electrically connected to a ground of the first circuit board; and the second filter is placed on the second circuit board and has one end electrically connected to the first hinge and a remaining end electrically connected to a ground of the second circuit board.

7. The portable radio according to claim 1, further comprising a second hinge joining the first housing to the second housing so as to be rotatable around a remaining axis that is orthogonal to the one axis and having conductivity.

8. The portable radio according to claim 7, further comprising at least one of:
a first reactance element having one end electrically connected to the first hinge and a remaining end electrically connected to the second hinge;
a second reactance element having one end electrically connected to the first hinge and a remaining end electrically connected to the ground of the first circuit board or the second circuit board; and
a third reactance element having one end electrically connected to the second hinge and a remaining end electrically connected to the ground of the first or second circuit board.
